(19) United States
(12) Patent Application Publication
(10) Pub. No.: US 2006/0150135 A1
(43) Pub. Date: Jul. 6, 2006

(54) Circuit information generating apparatus and circuit information generating method

(76) Inventors: Tomoo Hamada, Ibaraki-shi (JP); Hajime Ogawa, Suita-shi (JP); Ryoko Miyachi, Nishinomiya-shi (JP); Shohei Michimoto, Takatsuki-shi (JP); Yasuhiro Yamamoto, Kyoto-shi (JP); Teruo Kawabata, Suita-shi (JP); Hirotetsu Tomita, Nishinomiya-shi (JP)

Correspondence Address: MCDERMOTT WILL & EMERY LLP, 600 13TH STREET, N.W., WASHINGTON, DC, 20005-3096, US

(21) Appl. No.: 11/290,806

(22) Filed: Dec. 1, 2005

(30) Foreign Application Priority Data
Dec. 1, 2004 (JP) 2004-349146

(51) Int. Cl. G06F 17/50

(52) U.S. Cl. 716/12

(57) ABSTRACT

Provided is an apparatus for generating circuit design information automatically clock gated, for the purpose of alleviating the burden of a designer in performing clock gating to a circuit. The apparatus having an obtaining unit operable to obtain functional structure information and execution sequence information from outside, the functional structure information defining a structure of a function and the execution sequence information defining an execution sequence of the function; a structure information generating unit operable to generate, according to the execution sequence information and the functional structure information, circuit structure information in register transfer level which defines a plurality of circuits that execute the function according to the execution sequence; a gated clock information generating unit operable to generate, according to the execution sequence information and the functional structure information, gated clock information in register transfer level which defines a clock control circuit that supplies, to each of at least one of the circuits, a gated clock that is set to halt clock input when the clock input is unnecessary; and an outputting unit operable to output the gated clock information together with the circuit structure information.

### BACKGROUND OF THE INVENTION

(1) Field of the Invention

The present invention relates to a technology of producing a logic circuit using circuit description in a high-level language. In particular, the present invention relates to an apparatus and a method for generating circuit description incorporating therein clock gating.

(2) Related Art

Recently, the structure of LSI (Large Scale Integration) is becoming more and more complex, and the design manhours are accordingly on the increase. Increase in design manhours suggests increase in time required for the LSI designing. Therefore so as to reduce the time, higher designing efficiency should be fostered. One kind of technologies used to obtain higher designing efficiency is high-order combination. The high-order combination converts processing described in a language used in software description (e.g. C language) into circuit information in existing RTL (Resister Transfer Level). Describing a circuit using a high-order language helps decrease the quantity of description, enhance the verification speed, and the like. Note that in description in RTL, a circuit is combined with FF (Flip Flop) and is represented in the form of a logic circuit.

In LSI designing, it has become a very important task to realize low power consumption with a view toward realizing longer operation hours for the battery, restriction of heat generation, and reduction in packaging cost.

Clock gating is one of design methods used to realize low power consumption. In the technology of clock gating, unnecessary change in output is restrained by adding a control signal where there is a change in input to the circuit, and with respect to unnecessary input changes, invalidating them by means of a control signal. From circuitry point of view, output change in response to input change incurs power consumption. This means that if clock input is halted while there is no input change in a circuit, it helps reduce power consumption. Japanese Patent publication No. 2002-366596 discloses one conventional clock gating method.

In such a conventional clock gating method, however, a circuit designer infers suitable circuits where clock gating is expected to realize low power consumption efficiently, and describes the circuits as incorporating the clock gating in the first place. This process is troublesome for circuit designers, and takes up much time.

### SUMMARY OF THE INVENTION

In view of the above, so as to alleviate the burden on the designer in performing clock gating to the circuit including an LSI circuit, the present invention aims to provide an apparatus for generating circuit description capable of generating a circuit to which clock gating is provided automatically during high-rank combination from a high-level language into RTL.

So as to solve the above-stated program, the present invention provides a circuit information generating apparatus of a circuit information generating apparatus having an obtaining unit operable to obtain functional structure information and execution sequence information from outside, the functional structure information defining a structure of a function and the execution sequence information defining an execution sequence of the function; a structure information generating unit operable to generate, according to the execution sequence information and the functional structure information, circuit structure information in register transfer level which defines a plurality of circuits that execute the function according to the execution sequence; a gated clock information generating unit operable to generate, according to the execution sequence information and the functional structure information, gated clock information in register transfer level which defines a clock control circuit that supplies, to each of at least one of the circuits, a gated clock that is set to halt clock input when the clock input is unnecessary; and an outputting unit operable to output the gated clock information together with the circuit structure information.

What is meant by the function is information sufficiently defining input/output, function, and operation timing of a circuit. The function may be a program described in C language or may be circuit design information described in RTL. In addition, what is meant by the expression “that is set to halt clock input” is to fix the high/low of the clock input, i.e. to halt change in clock input.

With the stated structure, the circuit information generating apparatus of the present invention obtains a program in C language or circuit design information for designing a circuit in RTL, and generates circuit information that includes a circuit executing clock gating as well as a circuit executing the program and the circuit design information, thereby enabling automatic generation of circuit information into which a clock gating technology has been incorporated. Therefore, it becomes possible to alleviate the burden on the designer in performing clock gating to circuits.

In addition, the stated circuit information generating, apparatus may have a structure in which the execution sequence is composed of a plurality of states, each state being assigned a corresponding position in the execution sequence and including at least one instruction, the structure information generating unit includes: a first information generating subunit operable to generate first information defining a state machine that manages the states and outputs a state signal, the state signal indicating which order of the execution sequence a particular state corresponds to; and a second information generating subunit operable to generate second information defining an operation processing circuit that executes contents of the state according to the state signal, the gated clock information generating unit includes: a third information generating subunit operable to generate third information defining a control signal generating circuit, the control signal generating circuit retaining a clock signal control table indicating, for each of the circuits and according to each of the states, whether clock input to the circuit is necessary, and generating a clock control signal conforming to the state signal after reception of the state signal; and a fourth information generating subunit operable to generate fourth information defining a clock gating circuit that, according to the clock control signal, generates a gated clock that is set to halt clock input while a corresponding circuit is not functioning and supplies the gated clock to the operation processing circuit, the circuit structure information is generated to include the first information and the second information, and the gated clock information is generated to include the third information and the fourth information.

Here, the state machine checks transition of states into which the execution sequence is divided. What is meant by “manages the states” is to retain information about a current state in which the circuit is operating. The state includes processing to execute part of the function.

With the stated structure, it becomes possible to generate circuit information that includes a gated clock circuit in addition to a circuit composed of a state machine and an operation processing circuit.

In addition, the stated circuit information generating apparatus may have a structure in which the gated clock information generating unit further includes: a fifth information generating subunit operable to generate fifth information defining a control signal adjusting circuit that generates an adjusted clock control signal by correcting delay of the clock control signal after receiving the clock control signal, and generates the gated clock information to include therein the fifth information.

If a circuit is generated based on information generated by the circuit information generating apparatus of the present invention, the circuit is able to correct delay of a clock control signal, to generate a correct gated clock synchronized with the clock input, and to supply the correct gated clock to the operation processing circuit.

In addition, the stated circuit information generating apparatus may have a structure in which the control signal generating circuit: retains a priority value table that indicates, for each of circuits included in the operation processing circuit, a power reducing effect expected of gated clock supply to the circuit included in the operation processing circuit; and detects, using the priority value table, two gated clocks respectively to he supplied to two circuits exhibiting lowest power reducing effects of the circuits included in the operation processing circuit, and the clock control circuit combines the detected two gated clocks to generate a combined gated clock, and supplies the combined gated clock to the two circuits.

In usual cases, clock lines are necessary respectively for circuits constituting the operation processing circuit. If the number of clock lines becomes considerably large, the amount of power consumed by the clock lines becomes unnegligible. However in the above-stated structure, combining of clock lines is performed for each two clock lines. Therefore with the structure, it becomes possible to prevent increase in power consumption due to increase in the number of clock lines Combining of gated clocks for preventing increase in power consumption due to increase in the number of clock lines sometimes counteracts the effect of power consumption reduction by providing gated clocks. Therefore, in the actual circuit, the apparatus should be mounted taking into consideration of the real power consumption effects of the both cases. Please note here that a clock line is a signal line via which a clock is supplied to a circuit.

In addition, the obtaining unit may obtain a program in C language which includes the functional structure information and the execution sequence information.

With the stated structure, the circuit information generating apparatus of the present invention is able to obtain circuit information in RTL based on the C language program. In reality, the programming with use of C language is common in the functional specification designing stage, and the circuit design information in RTL becomes important for the actual mounting. Therefore the designer should find the stated structure important, in terms of saving several processes in the circuit designing.

The present invention also provides a circuit information generating method for generating circuit information incorporating therein a clock gating circuit, the method having: an obtaining step of obtaining functional structure information and execution sequence information from outside, the functional structure information defining a structure of a function and the execution sequence information defining an execution sequence of the function; a structure information generating step of generating, according to the execution sequence information and the functional structure information, circuit structure information in register transfer level which defines a plurality of circuits that execute the function according to the execution sequence; a gated clock information generating step of generating, according to the execution sequence information and the functional structure information, gated clock information in register transfer level which defines a clock control circuit that supplies, to each of at least one of the circuits, a gated clock that is set to halt clock input when the clock input is unnecessary; and an outputting step of outputting the gated clock information together with the circuit structure information.

The present invention also provides a circuit information generating program for generating circuit information incorporating therein a clock gating circuit, the program being for executing: an obtaining step of obtaining functional structure information and execution sequence information from outside, the functional structure information defining a structure of a function and the execution sequence information defining an execution sequence of the function; a structure information generating step of generating, according to the execution sequence information and the functional structure information, circuit structure information in register transfer level which defines a plurality of circuits that execute the function according to the execution sequence; a gated clock information generating step of generating, according to the. execution sequence information and the functional structure information, gated clock information in register transfer level which defines a clock control circuit that supplies, to each of at least one of the circuits, a gated clock that is set to halt clock input when the clock input is unnecessary; and an outputting step of outputting the gated clock information together with the circuit structure information.

With the stated method and the stated program, it becomes possible to generate circuit information into which gated clock is incorporated.

The stated circuit information generating method may have a structure in which the execution sequence is composed of a plurality of states, each state being assigned a corresponding position in the execution sequence and including at least one instruction, the structure information generating step includes: a first information generating substep of generating first information defining a state machine that manages the states and outputs a state signal, the state signal indicating which order of the execution sequence a particular state corresponds to; and a second information generating substep of generating second information defining an operation processing circuit that executes contents of the state according to the state signal, the gated clock information generating step includes: a third information generating substep of generating third information defining a control signal generating circuit, the control signal generating circuit retaining a clock signal control table indicating, for each of the circuits and according to each of the states, whether clock input to the circuit is necessary, and generating a clock control signal conforming to the state signal after reception of the state signal; and a fourth information generating substep of generating fourth information defining a clock gating circuit that, according to the clock control signal, generates a gated clock that is set to halt clock input while a corresponding circuit is not functioning and supplies the gated clock to the operation processing circuit, the circuit structure information is generated to include the first information and the second information, and the gated clock information is generated to include the third information and the fourth information.

The stated circuit information generating program may have a structure in which the execution sequence is composed of a plurality of states, each state being assigned a corresponding position in the execution sequence and including at least one instruction, the structure information generating step includes: a first information generating substep of generating first information defining a state machine that manages the states and outputs a state signal, the state signal indicating which order of the execution sequence a particular state corresponds to; and a second information generating Substep of generating second information defining an operation processing circuit that executes contents of the state according to the state signal, the gated clock information generating step includes: a third information generating substep of generating third information defining a control signal generating circuit, the control signal generating circuit retaining a clock signal control table indicating, for each of the circuits and according to each of the states, whether clock input to the circuit is necessary, and generating a clock control signal conforming to the state signal after reception of the state signal; and a fourth information generating substep of generating fourth information defining a clock gating circuit that, according to the clock control signal, generates a gated clock that is set to halt clock input while a corresponding circuit is not functioning and supplies the gated clock to the operation processing circuit, the circuit structure information is generated to include the first information and the second information, and the gated clock information is generated to include the third information and the fourth information.

With the stated method and the stated program, it becomes possible to generate circuit information that includes a circuit incorporating a gated clock technology in addition to a circuit made of a state machine and an operation processing circuit.

The stated circuit information generating method may have a structure in which the gated clock information generating step further includes: a fifth information generating substep of generating fifth information defining a control signal adjusting circuit that generates an adjusted clock control signal by correcting delay of the clock control signal after receiving the clock control signal, and generates the gated clock information to include therein the fifth information.

The stated circuit information generating program may have a structure in which the gated clock information generating step further includes: a fifth information generating substep of generating fifth information defining a control signal adjusting circuit that generates an adjusted clock control signal by correcting delay of the clock control signal after receiving the clock control signal, and generates the gated clock information to include therein the fifth information.

With the stated method and the stated program, it becomes possible to generate information about a clock control signal adjusting circuit capable of correcting delay of a clock control signal controlling clock input.

The present invention also provides a gated-clock combining method of combining gated clocks supplied to a plurality of circuits respectively, the method having: a retaining step of retaining a priority value table that indicates, for each of a plurality of circuits included in an operation processing circuit, a power reducing effect expected of gated clock supply to the circuit included in the operation processing circuit; a detecting step of, using the priority value table, detecting two gated clocks respectively to be supplied to two circuits exhibiting lowest power reducing effects of the circuits included in the operation processing circuit; a combining step of combining the detected two gated clocks to generate a combined gated clock; and a supplying step of supplying the combined gated clock to the two circuits.

The present invention also provides a gated-clock combining program for combining gated clocks supplied to a plurality of circuit respectively, the program being for executing: a retaining step of retaining a priority value table that indicates, for each of a plurality of circuits included in an operation processing circuit, a power reducing effect expected of gated clock supply to the circuit included in the operation processing circuit; a detecting step of, using the priority value table, detecting two gated clocks respectively to be supplied to two circuits exhibiting lowest power reducing effects of the circuits included in the operation processing circuit; a combining step of combining the detected two gated clocks to generate a combined gated clock; and a supplying step of supplying the combined gated clock to the two circuits.

With the stated method and the stated program, it becomes possible to combine two gated clocks, and to reduce the number of clock lines for supplying gated clocks. By repeating this operation, the number of clock lines constituting the circuit becomes desirable for the designer.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a functional block diagram of a circuit information generating apparatus relating to the present invention;

FIG. 2 is a functional block diagram of a circuit produced based on information generated by the circuit information generating apparatus relating to the present invention;

FIG. 3 is a diagram showing a structure of a clock gating unit 202;

FIG. 4 is a clock input information table indicating a necessity of clock input for each clock line and state;

FIGS. 5A and 5B are tables managed for preventing delay of clock input;

FIG. 6 is a diagram showing clock input, two gated clock examples, and a gated clock in which the two gated clocks are combined;

FIG. 7 is a priority value table that the control signal generating unit 201 requires in combining gated clocks;

FIG. 8 is a flowchart showing an operation of the circuit information generating apparatus of the present invention;

FIG. 9 is a flowchart showing a method of reducing the number of gated clock lines by combining;

FIG. 10 is a flowchart showing an operation performed by the control signal generating unit 201 in judging whether clock input is necessary or not;

FIG. 11 is a program 1100, being an example of a C language program 110;

FIG. 12 is a diagram showing the flowchart showing the result of execution contents of the program 1100;

FIG. 13 is a diagram showing the contents of the state machine while the program 1100 is executed by the circuit;

FIG. 14 is a schematic circuit diagram showing the contents of the program 1100;

FIGS. 15A and 15B show a clock signal control table 1500 and a priority value table 1510, which are managed by the control signal generating unit 201;

FIGS. 16A and 16B show a clock signal control table 1600 and a priority value table 1610, which are managed by the control signal generating unit 201;

FIGS. 17A and 17B show a clock signal control table 1700 and a priority value table 1710, which are managed by the control signal generating unit 201;

FIG. 18A and 18B show a clock signal control table 1800 and a priority value table 1810, which are managed by the control. signal generating unit 201; and

FIGS. 19A and 19B show a clock signal control table 1900 and a priority value table 1910, which are managed by the control signal generating unit 201.

### DESCRIPTION OF THE PREFERRED EMBODIMENTS

As follows, a circuit information generating apparatus relating to the present invention is described with reference to the drawings.

### First embodiment

<Overview>

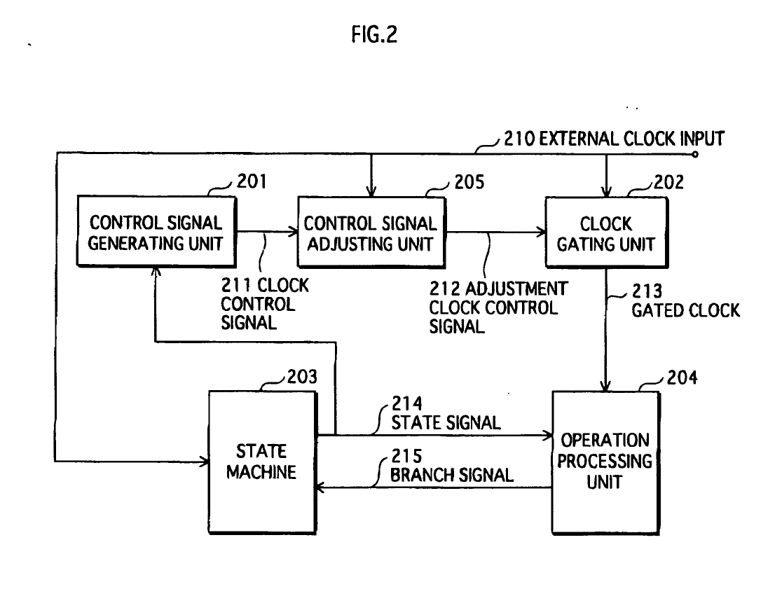

The circuit information generating apparatus of the present invention, based on a program in C language and the like, generates circuit design information as shown by a functional diagram of FIG. 2. Only for obtaining an accurate operation result, a state machine 203 and an operation processing unit 204 are sufficient for the circuit. But only with the state machine 204 and the operation processing unit 204, power consumption saving will not be achieved. The circuit is therefore made to further contain a control signal generating unit 201, a control signal adjusting unit 205, and a clock gating unit 202, for automatic generation of circuit design information.

<Structure>

(1) Structure of Circuit Information Generating Apparatus

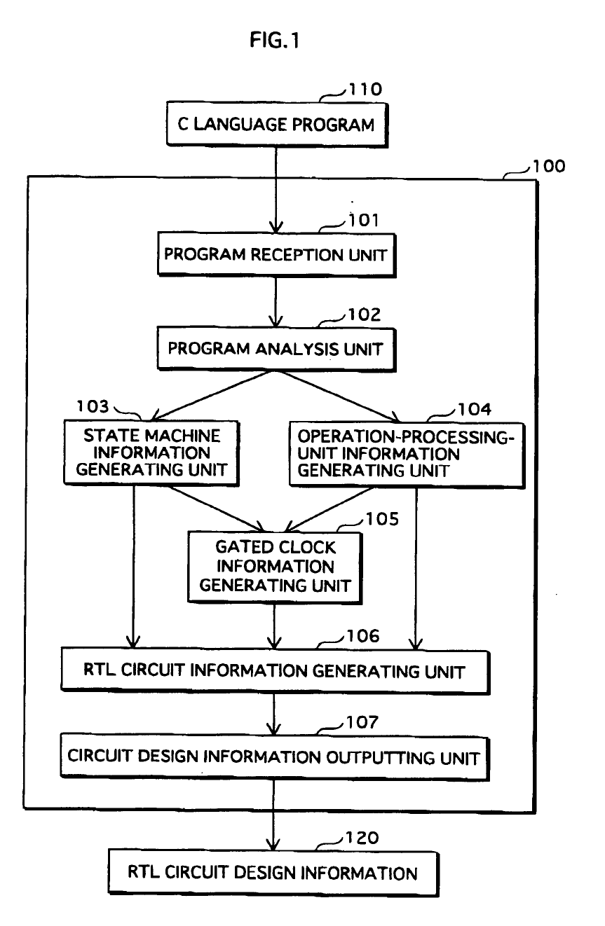

FIG. 1 is a functional block diagram of a circuit information generating apparatus 100 relating to the present invention.

The circuit information generating apparatus 100 includes a program reception unit 101, a program analysis unit 102, a state machine information generating unit 103, an operation processing unit information generating unit 104, a gated clock information generating unit 105, an RTL circuit information generating unit 106, and a circuit design information outputting unit 107.

In practice, the circuit information generating apparatus 100 includes a CPU (Central Processing Unit), a ROM (Read Only Memory), and a RAM (Random Access Memory). The circuit information generating apparatus 100 generates RTL circuit design information 120, by the CPU reading the program stored in the ROM, and executing the program while retaining data in the RAM.

The program reception unit 101 receives a C language program 110 from an external source.

The program analysis unit 102 checks the contents of the C language program 110 received by the program reception unit 101, and analyzes the execution contents and the execution sequence of the C language program 110. The analyzing method adopted is a conventional method.

The state machine information generating unit 103 generates information relating to a state machine that manages divided pieces of state information in the to-be generated circuit design information, for managing the execution sequence of the pieces of state information in an order prescribed in the operation description of the C language program 110 according to a response from the operation processing unit 204 actually executing an operation. Generally, a state machine is a digital device that causes predetermined states to transition according to a predetermined condition and a predetermined order.

The operation-processing-unit information generating unit 104 generates circuit information of the operation processing unit 204, in which circuits are appropriately related to each other in a sense that contents of the C language program 110 can be realized by detecting necessary operational circuits by referring to an analysis result of the program analysis unit 102.

The gated clock information generating unit 105 obtains information (clock input information) relating to clock input to be supplied to a plurality of circuits constituting the operation processing unit 204 in each state. The clock input information is obtained according to state machine information and operation-processing-unit information respectively generated by the state machine information generating unit 103 and the operation-processing-unit information generating unit 104. Where clock input is judged unnecessary according to the clock input information, the gated clock information generating unit 105 generates information about a circuit that generates a gated clock that is set to halt clock input. In this example, the gated clock information generating unit 105 generates, as gated clock information, circuit information for three functional units which are specifically: a control signal generating unit 201 for outputting a clock control signal for contolling clock input; a clock signal adjusting unit 205 for correcting delay of the clock control signal; and a clock gating unit 202 for generating a gated clock using the clock input and the clock control signal.

The RTL circuit information generating unit 106 generates RTL circuit design information 120 by using the information generated by the state machine information generating unit 103, the operation-processing-unit information generating unit 104, and the gated clock information generating unit 105. The generated RTL circuit design information 120 relates to circuits executing the contents of the c language program 110 while achieving low power consumption at the same time.

The circuit design information outputting unit 107 outputs the RTL circuit design information 120 generated by the RTL circuit information generating unit 106 to outside. The outputting method is not illustrated in the drawing, but adopts such methods as monitor display and printing of the RTL circuit design information 120.

(2) Structure of Circuit Produced Based on the RTL Circuit Design Information 120

Next, functions performed by units actually produced based on the RTL circuit design information 120 are explained using a functional block diagram of FIG. 2.

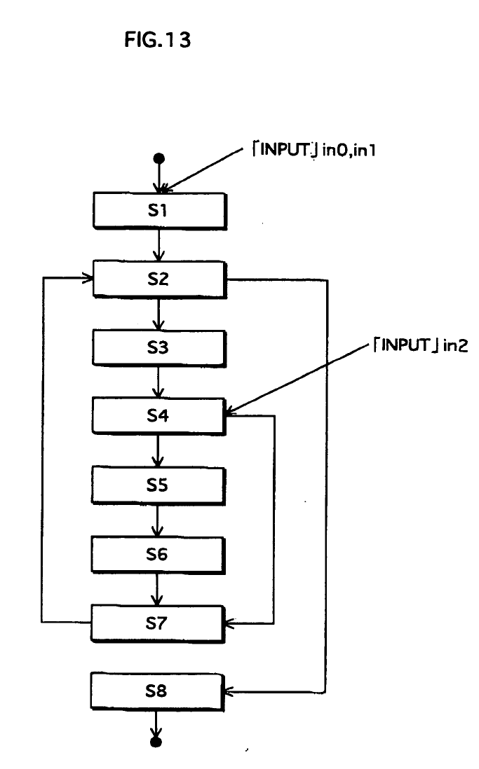

A state machine 203 manages operation contents to be executed by an operation processing unit 204 for each state (being an execution state of an operation), in the form of the state flow as shown in FIG. 13. The state machine 203 recognizes the current state, and outputs a state signal 214 indicating the current state to the operation processing unit 204. In receiving a branch signal 215 from the operation processing unit 204, the state machine 203 determines a destination state indicated by the operation result, thereby transmitting a new state signal. The state machine 203 is composed of a storage element and a sequential circuit.

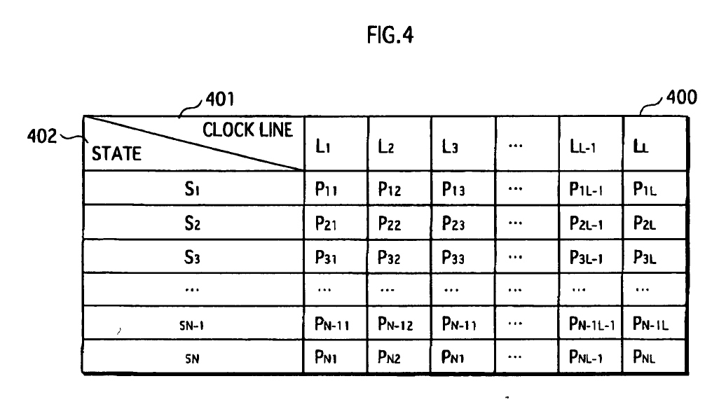

The control signal generating unit 201 receives a state signal 214 from the state machine 203, for obtaining information about the current state. Based on the state signal 214, the control signal generating unit 201 outputs a clock control signal 211 indicating necessity of clock input for each circuit in the state, by using a clock signal control table 400 as shown in FIG. 4. The clock signal control table 400 is retained to manage to which circuit clock input is necessary in each state. Specifically a circuit is determined as requiring clock input if the circuit is judged to perform an instruction in a state in the analysis about the contents of the instruction included in the state, by referring to the state machine 203 managing each state. The control signal generating unit 201 is composed of a storage element and a sequential circuit.

The control signal generating unit 201 decodes a state signal 214 received from the state machine 203. Therefore in practice, this generates a signal delay. In principle, this signal delay is less than one cycle delay. This problem of signal delay is countered by outputting a clock control signal for the state next to the state obtained by the state signal, by taking into account the less than one cycle delay.

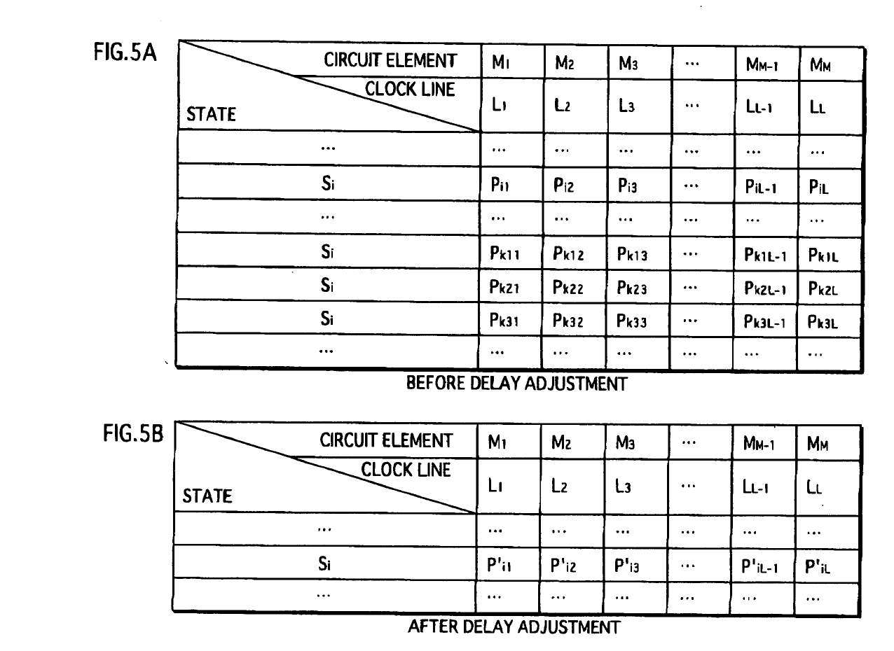

Specifically, if a delay is worth d cycles (d being an integer of 2 or above), then a clock control signal corresponding to the state after d cycles is outputted. Here, there is a possibility that several states to be executed exist after the d cycles, depending on the branch condition during the d cycles. In view of this, the logical OR is carried out to clock control signals for the states having a possibility of being executed after the d cycles. For example, suppose a case of FIG. 5A where there are a plurality of states after the d cycles, with clock lines Lᵢ-L_{L}, and the clock line L₁ has clock control signals Pᵢ₁-Pₖ₃₁, for example. In this case, a clock control signal for the clock line L₁ is calculated by carrying out the logical OR among the clock control signals Pᵢ₁-Pₖ₃₁, and the resulting P′ᵢ₁ is outputted as the clock control signal for the clock line L₁, as shown in FIG. 5B. Specifically, the equation for obtaining the P′ᵢ₁ is as follows.
P′ᵢ₁=Pᵢ₁|. . . |Pₖ₁₁|Pₖ₂₁|Pₖ₃₁

The control signal adjusting unit 205 is a FF that, when there occurs a delay of a cluck control signal 211 generated by the control signal generating unit 201 undergoes delay and so cannot attain synchronization with the clock input, corrects the delay and outputs the clock control signal 212 after the correction. The control signal generating unit 201 has to decode a state signal 214, which takes time. This is why the clock control signal 210 may well be delayed at the time of being outputted from the control signal generating unit 201. The control signal adjusting unit 205 latches the clock control signal 211, so as to realize synchronization between each state and clock input. This technology of delay adjustment has been performed conventionally. In principle, there will be only about less than one cycle delay, therefore the latch worth one cycle is performed.

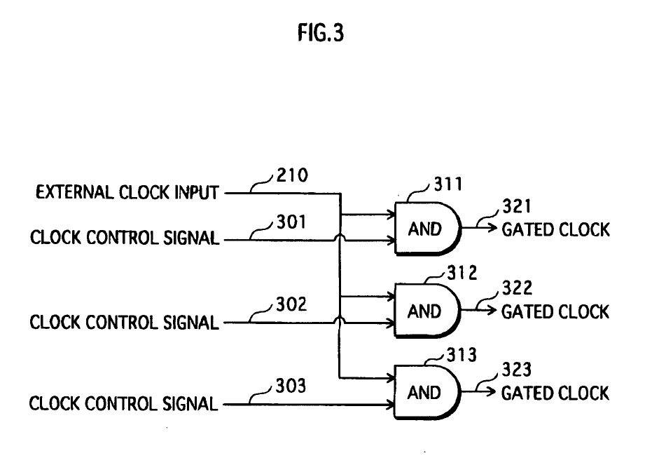

The clock gating unit 202 receives an adjustment clock control signal 212 and generates a gated clock 213 to be outputted to a circuit (register) constituting the operation processing unit 204. The clock gating unit 202 is structured as in FIG. 3. Specifically, a signal generated by carrying out the logical AND between the external clock input 210 and the adjustment clock control signal 212 is outputted as a gated clock 213. Basically, the number of gated clocks 213 corresponds to the number of the circuits in principle. In FIG. 3, the AND circuits 311, 312, and 313 respectively output gated clocks 321, 322, and 323, by carrying out the logical AND between the clock control signals 301, 302, 303, and the external clock input 210 respectively. Gated clocks may also well be delayed in undergoing the AND circuits, but consistency is maintained in the entire circuit by incorporating the buffer (not illustrated in the drawings) into the circuit.

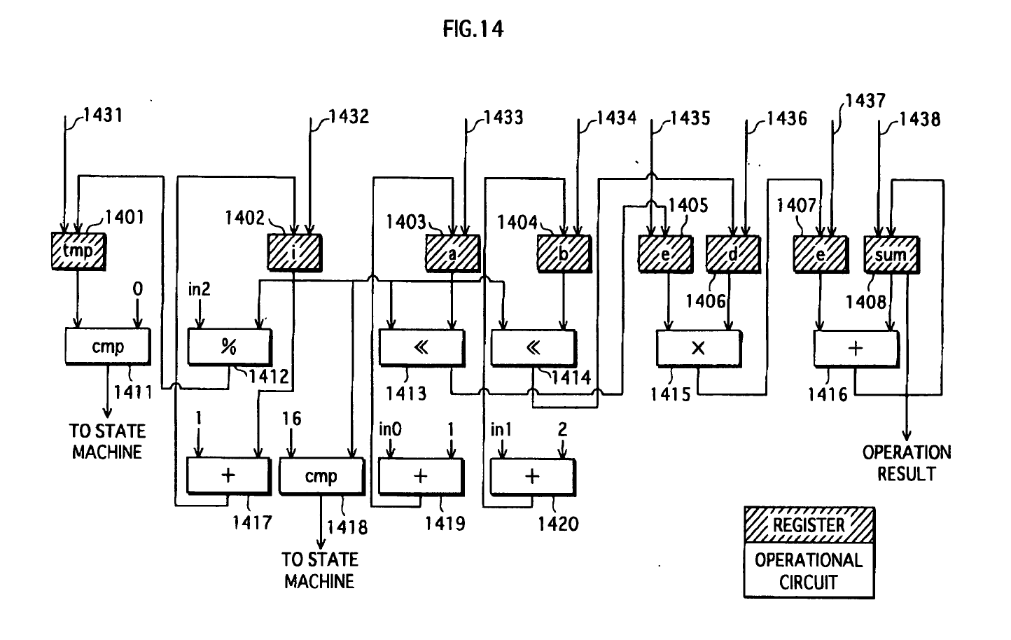

The operation processing unit 204 is composed of circuits actually executing operations. One example expressing the operation processing unit 204 by means of logical circuits and FFs is shown in FIG. 14. The operation processing unit 204 executes operations by referring to the state signal 214 given by the state machine 203 and the gated clock 213 transmitted from the clock gating unit 202. Then each time after executing the operation contents corresponding to an end of a state, the operation processing unit 204 returns a branch signal 215 to the state machine 203. Upon reception of a next state signal 214, the operation processing unit 204 executes the next operation. The operation processing unit 204 repeats the above-stated processing until obtaining an operation result that the program desires to obtain.

<Data>

The following describes data involving the circuit information generating apparatus 100, which relates to the present invention.

(1) Input Information

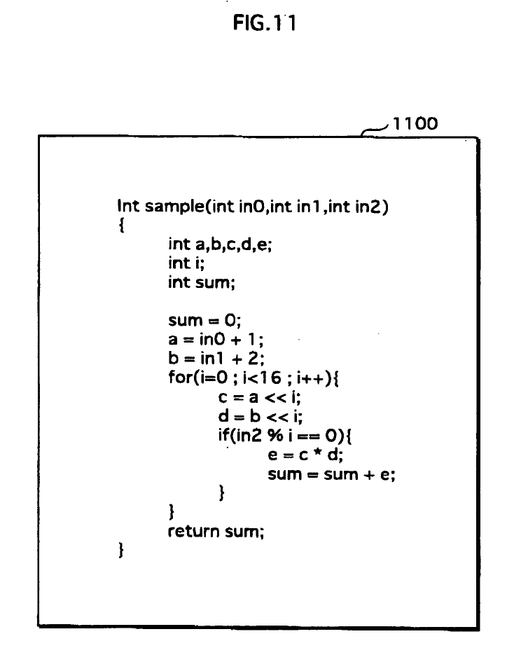

FIG. 11 shows one example of a C language program, being input information that the circuit information generating apparatus 100 obtains, relating to the present invention.

The C language program of FIG. 11 is one example of the C language program 110 received by the program reception unit 101 of FIG. 1.

Concrete execution contents thereof is briefly explained as follows.

The program 1100 uses variables a, b, c, d, e, i, sum, and initial inputs in0, in1, in2, thereby obtaining a value of sum as a result. The following gives a simple explanation on the sequential operations. First of all, 0 is substituted into sum, a value obtained by adding 1 to in0 is substituted into a, and a value obtained by adding 2 to in1 is substituted into b.

Then a value is substituted into i while i=0-15, in the order of i=0, 1, 2 . . . , where the value to be substituted is obtained by adding e to the value of sum defined earlier when the remainder of division of the value of in2 by i is 0. e is obtained by multiplying c by d, and c is obtained by multiplying a by 2ⁱ, and d is obtained by multiplying b by 2ⁱ. When i=16, the operation is ended, and the value of sum at the moment is returned as an operation result.

(2) Analysis Information

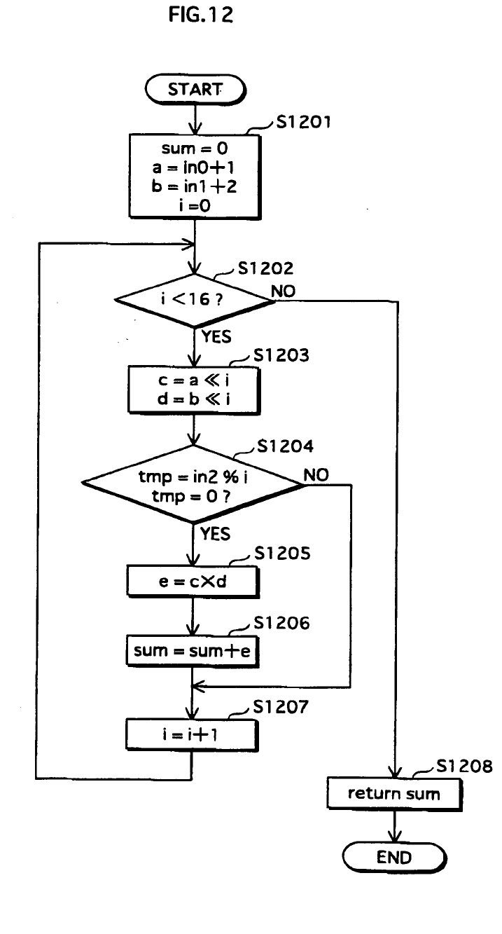

The program analysis unit 102 divides the contents of C language program 110, being input information, into a unit of states, according to branch conditions and instructions executable in parallel, and analyzes an execution relation among the states. FIG. 12 shows contents of analysis information of the program 1100. This drawing shows the contents of analysis information in the form of flow, so as to facilitate understanding Such information is obtained by analysis. When the program 1100 is analyzed, 8 states (from State S1201 to State 1208) will result. An analysis Method adopted is a conventional technology used in high-order combination. Each state contains at least one instruction in principle, state transition is caused in the order from state S1201 to state S1208 State S1202 and state S1204 have two transition destinations. From state S1201, transition is performed to state S1203 and to state S1208. From state S1204, transition is performed to state S1205 and to state S1207.

(3) State Machine Information

The state machine is a directed graph which is composed of nodes respectively representing states, and conversion functions corresponding to the nodes. One example of the state machine is shown in FIG. 13. FIG. 13 shows apart of state machine information created based on the program 1100.

The state machine information is created by the analysis of the program analysis unit 102 based on the execution flow as shown by FIG. 12. The state machine information is information about a circuit that i) retains a directed graph specifying each branch destination of states according to branch conditions of the program 1100 and the like and according to the execution flow of the program 1100, where each state is a set of instructions executable in parallel, and ii.) outputs a state signal, being state information, by checking the state transition with reference to the operation result.

FIG. 13 shows a flow of states created based on the program 1100 and managed by the state machine. States S1-SB respectively correspond to the states S1201-S1208 of FIG. 12. The state machine information can be created using a conventional high-order combination technology. The states arc subjected to transition in accordance with an operation result and the like.

(4) Information About the control signal generating unit 201

Information about the control signal generating unit 201 means information according to which the control signal generating unit 201 is generated, and is specifically information about a circuit that i) retains the clock signal control table 400 as shown in FIG. 4, and ii) outputs a clock control signal corresponding to a state signal having received from the state machine. The clock signal control table 400 is a table showing, in cach state managed by the state machine, whether clock input is necessary for each circuit of the operation processing unit 204.

The clock signal control table 400 indicates necessity of clock input for each clock line 401 in each state 402. Pᵢⱼ (i and j are respectively integers of 1 or above) is expressed as a value of 0 or 1. When clock input is necessary, 0 is assigned, whereas when clock input is unnecessary, 1 is assigned. The clock signal control table 400 is created assuming that clock input is necessary for every register that corresponds to a variable into which a value is substituted in a corresponding state's operation (i.e. corresponding to a variable whose value changes in the state's operation). Whether there is such substitution of a value or change of value for a variable in each state is known by the analysis performed by the program analysis unit 102.

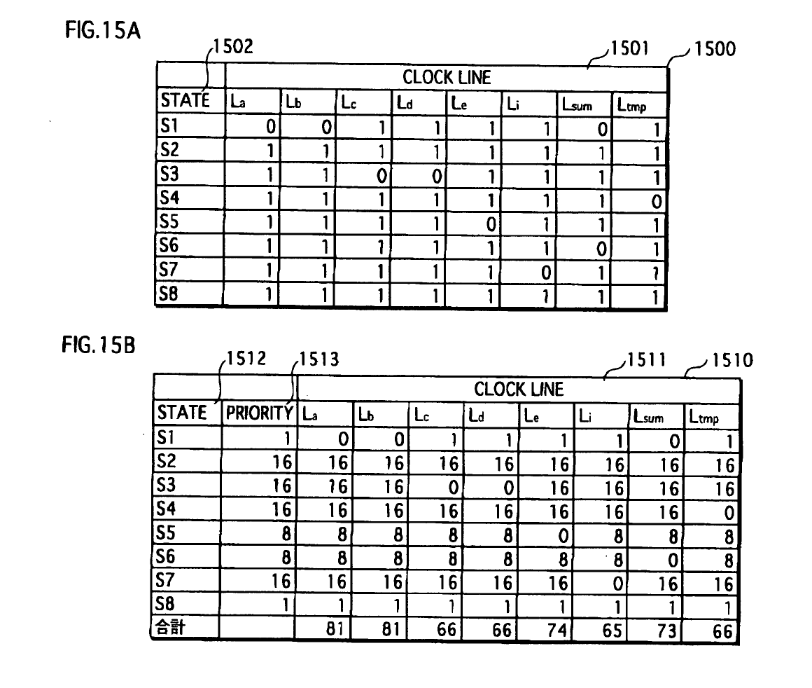

An example of the clock signal control table 400 is shown in FIG. 15A. FIG. 15A shows a clock signal control table 1500 created based on the program 1100.

The clock signal control table 1500 contains states 1502 and clock lines 1501. For each state and clock line, necessity of clock input is indicated using 0 and 1. As already described above, when clock input is necessary, 0 is assigned, whereas when clock input is unnecessary, 1 is assigned. The clock lines Lₐ, L_{b}, L_{c}, L_{d}, Lₑ, Lᵢ, Lₛᵤₘ, and Lₜₘₚ respectively indicate clock lines for supplying gated clocks connected to registers respectively corresponding to variables of a, b, c, d, e, i, sum, and tmp. The control signal generating unit 201 outputs a clock control signal 211, based on this clock signal control table 1500 and the state signal received from the state machine. This clock control signal 211 is subjected to the logical AND with the clock input in the clock gating unit 202, and so indicates values reverse to 0 and 1 of this table.

(5) Information About the Control Signal Adjusting Unit 205

Information about the control signal adjusting unit 205 is information about an FF or about a latch circuit. Signal delay is controlled by performing a temporary latch via the FF for use as signal adjustment. This delay correction method has been performed conventionally, and so the control signal adjusting unit 205 adopts a circuit conventionally used therefor.

(6) Information About the Clock Gating Unit 202

Information about the clock gating unit 202 is circuit design information as shown in FIG. 3. FIG. 3 is a schematic circuit diagram. The circuit design information in the drawing is such that an AND circuit connects a signal line for a clock control signal to a signal line for an external clock, via which a gated clock is outputted. In FIG. 3, the logical AND is performed on the external clock 210 with clock control signals 301, 302, and 303, respectively in the AND circuits 311, 312, and 313, thereby outputting gated clocks 321, 322, and 323. The number of the AND circuits corresponds to the number of circuits that require clock input (basically corresponding to the number of the circuits). Gated clocks to be outputted are connected so as to be supplied to respective circuits constituting the operation processing unit 204.

(7) Information About the Operation Processing Unit 204

Next, information about the operation processing unit 204 is described. The operation processing unit 204 is a circuit performing actual operations. Circuit design information of the circuit corresponds to the information about the operation processing unit 204. FIG. 14 shows circuit design information according to which the operation processing unit 204 is generated, the operation processing unit 204 being based on the program 1100 and for performing actual operations. Here, the circuit design information is illustrated in the form of a schematic circuit diagram.

Variables used by the program 1100, namely, a, b, c, d, e, i, and sum are respectively stored in the registers 1403, 1404, 1045, 1406, 1407, 1402, and 1408. In FIG. 14, the registers and the operational circuits are indicated using the corresponding representations in the program 1100 so as to facilitate understanding of the execution contents.

Clock lines 1431, 1432, . . . , 1438 are respectively used to supply gated clocks from the clock gating unit 202 to the registers 1401, 1402, . . . , 1408. Upon reception of clock input, the operational circuit connected to each register will gain a value, thereby starting operation execution. “tmp” assigned to a register 1401 indicates that it is a register for storing a result of the modulo operation in the line 13 of the program 1100. The modulo operation is for obtaining a remainder that results by a division operation. Here, the remainder of division of in2 by i is stored in the register 1401.

In addition, each of the operational circuits in FIG. 14 corresponds to an operational circuit indicated in the program 1100. The operational circuits 1411 and 1418 compare two inputted values, and the operational circuit 1412 performs the modulo operation. The operational circuits 1413 and 1414 perform the left shift operation. The left shift operation is a bitwise left shift operation. For example, 2 in binary is expressed in decimal as “0010”. In this notation, when 1 is moved 2 bits to left, “1000” will result. “1000” is expressed in binary as 8. In this operation, 2 became 8, which is the original value times 4, i.e. 2 multiplied by 2².

The operational circuit 1415 performs multiplication. The operational circuits 1416, 1417, 1419, and 1420 perform addition For example, the operational circuit 1412 corresponds to the modulo operation in the if statement. The operational circuit 1413 corresponds to an operation to move a value of a to the left by i bits, as indicated in the program 1100 as “a<<i”.

The information about the operation processing unit 204 can also be generated using a conventional high-order combination.

The circuit information generating apparatus 100 receives the program 1100 as illustrated in FIG. 11, and generates circuits for executing the contents of the program 1100 based on the received program 1100, thereby generating circuit structure information by which gated clock supply is enabled onto the generated circuits.

(8) General Data to be Generated

Generated information is a combination of: circuit information for retaining such a state flow as shown in FIG. 12 and generating a state signal; information that is described in RTL and is about such an operational circuit as shown in FIG. 13, the operational circuit executing actual operations; information about a circuit that manages a clock signal control table as shown in FIG. 15A and that is for outputting a clock control signal appropriate for the state that corresponds to a received state signal, the clock signal control table indicating to which register clock input is necessary in each state; circuit information about the control signal adjusting unit 205 that outputs an adjustment clock control signal by correcting delay of a clock control signal; and circuit information about the clock gating unit 202 that inputs an adjustment clock control signal outputted from the control signal adjusting unit 205 and clock input to the AND circuit as shown in FIG. 3, thereby generating a gated clock, and inputs the generated gated clock to a corresponding circuit (register) within the operation processing unit 204.

<Operation>

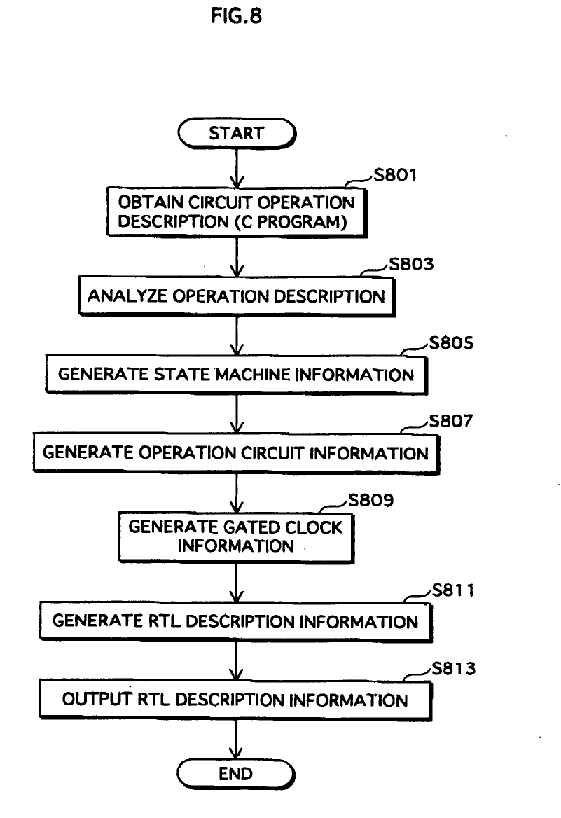

The generating flow of the circuit design information of the circuit information generating apparatus, which relates to the present invention, is described below with use of the flowchart of FIG. 8.

First of all, the program reception unit 101 receives the C language program 110 (Step S801). Then the program analysis unit 102 receives the C language program 110 via the program reception unit 101, analyzes the contents, and converts it into analysis information as shown by the flow of FIG.,12 (Step S803). The state machine information generating unit 103, based on thus generated analysis information, creates a state flow as shown in FIG. 13 for managing the states, and generates information about the state machine that manages the state flow (Step S805). The operation-processing-unit information generating unit 104 generates information showing a circuit structure as shown in FIG. 14, which specifies the structure of operational circuits that become necessary in reality, and registers for storing data (Step S807). Then the gated clock information generating unit 105 receives information relating to the states from the state machine generated using the state machine information, and generates gated clock information for generating gated clocks to be given to the operation-processing-unit information generating unit 104 (Step S809). Information about a gated clock to be supplied Lo each circuit of the operation processing unit 204 is generated for each state based on the contents of an instruction executed in the state indicated by the state machine and the response of the circuits in the operation processing unit 204 that execute the instruction. In generating circuit information of the state machine and the operation processing unit 204, a conventional high-order rank combination technology is employed. Then the RTL circuit information generating unit 106 generates circuit information in RTL using the state machine circuit information, the operational circuit information, and the gated clock circuit information (Step S811). Then the circuit design information outputting unit 107 outputs thus generated information by means of monitor display, printing, and the like, thereby ending the processing (Step S813).

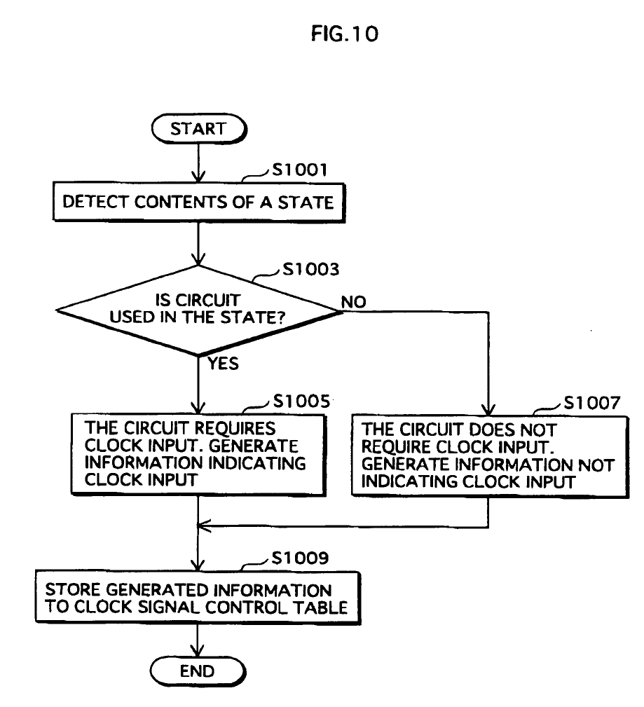

Next, the following describes a method of producing a clock signal control table managed in the control signal generating unit 201 within the circuits actually produced based on the generated information, with use of the flow chart of FIG. 10.

First, information about a state is received from the state machine, and the contents of the state is detected (Step S1001). Then every circuit used in the state is detected by referring to the contents of the state. For example, for the program 1100, this detection is performed by judging whether there is a value change for each register in the state, by analyzing the execution contents of the state (Step S1003). Then if a circuit is judged to be used in the state (Step S1003: YES), this means that clock input is necessary to the circuit, and so a clock control signal including the information for performing clock input is outputted (Step S1005). For example, in the state S1201 according to the program 1100, it is understood that a value change occurs as a result of substituting 0 into the variable sum, and accordingly a register corresponding to the variable sum is judged to require clock input. If a circuit is judged not to be used in the state (Step S1003: NO), this means that clock input is not necessary to the circuit, and so a clock control signal including information for halting clock input is outputted (Step S1007). Then clock control signals respectively indicating whether to perform clock input to the circuits in each state are stored in the clock signal control table, thereby ending the processing (Step S1009).

Next, an actual operation of each circuit generated based on the RTL circuit design information 120 is described as follows with use of the functional diagram of FIG. 2. First, the state machine 203 outputs a state signal indicating a state of the program, of which the instruction(s) is to be executed. The control signal generating unit 201 outputs a clock control signal 211 relating to the state next to the state indicated by the state signal, by taking into account the delay calculated based on the state signal. The control signal adjusting unit 205, while temporarily latching the clock control signal for prevention of expected delay, outputs an adjustment clock control signal 212 for synchronization with the external clock input 210. The clock gating unit 202 generates a gated clock 213 based on the adjustment clock control signal 212 and the external clock input 210. Then based on the gated clock 213 and the state signal 214, the operation processing unit 204 controls a corresponding circuit to execute an operation, until there is no instruction left for execution. Note that the state machine 203 is able to recognize a branch destination resulting from an operation result, determine the next state, and output a new state signal 214, by referring to a branch signal 215 received from the operation processing unit 204.

### Second Embodiment

As follows, the second embodiment of the present invention is described with use of the drawings.

The second embodiment relates to a method of reducing the number of clock lines in case of considerable increase in the number of gated clocks to be supplied to each register, with a view toward decreasing power consumption and heat quantity emitted from the circuits. This embodiment is advantageous not only from a viewpoint of alleviating the troubles incurred in the actual circuit production, but also from a viewpoint of prevention in circuit area increase. In the circuit information generating apparatus 100, the gated clock information generating unit 105 generates information in which the number of gated clocks is reduced.

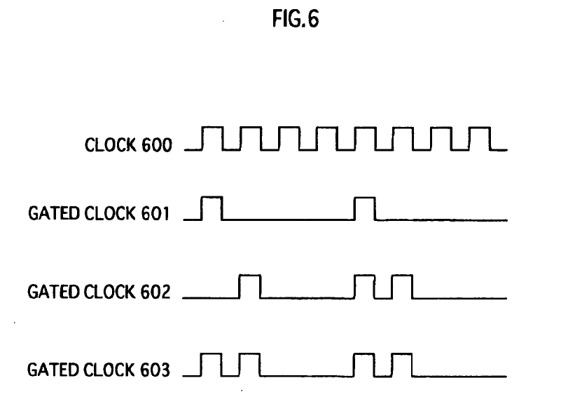

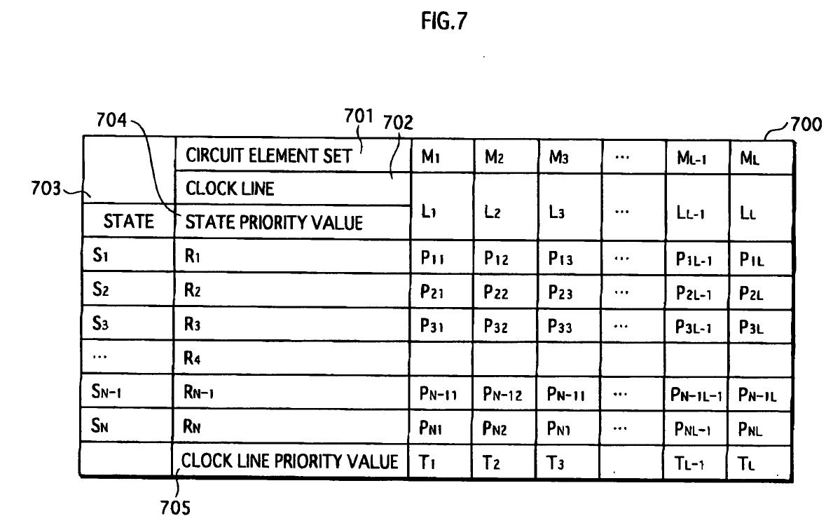

A concrete method of reducing the number of clock lines for gated clocks is described with use of FIGS. 6 and 7, and the tables of FIGS. 15-19.

<Outline>

In outline, it is possible to reduce the number of clock lines by repetition of combining two gated clocks that both have a small low consumption effect as a result of gated clock supply, where the gated clocks are among gated clocks whose number corresponds to the number of the entire circuits.

Here, combining of two clock lines corresponding to two gated clocks means to perform the logical OR between the two gated clocks. For example, in FIG. 6, it is assumed that clock input is 600, a circuit 1 receives a gated clock 601, and a circuit 2 receives a gated clock 602. In this example, by combining the gated clock 601 and the gated clock 602, a gated clock 603 results. This gated clock 603 is supplied to both of the circuit 1 and the circuit 2, instead of the gated clock 601 and the gated clock 602 having been supplied respectively.

<Data>

The control signal generating unit 201 retains a priority value table 700 as shown in FIG. 7 in addition to the clock control signal table. This priority value table 700 retains priority values respectively for the states for the purpose of reducing the number of gated clocks. The priority value table 700 is to be under management of the control signal generating unit 201. In the priority value table 700, each state 703 is assigned a corresponding state priority value 704. For example, a priority value R₁ is assigned to a state S₁. The number of the circuit element sets 701 is the same as the number of the clock lines 702, and they correspond to each other in a sense that each circuit element set 701 is provided with one clock line 702. A state S₁ of a clock line L₁ indicates a priority value of P₁₁. P₁₁ is obtained by multiplying, by the state priority value R₁ of FIG. 7, the value of 0 or 1 at the state S₁ of the clock line L₁ of the clock signal control table 400 of FIG. 4. Each clock line priority value 705 indicates a summation of all the priority values for a corresponding clock line. A clock line priority value Tⱼ is calculated using the following expression 1:

$${T}_{j} = {\sum }_{i = 0}^{N} flag ( {P}_{ij} ) \times prio ( {S}_{i} )$$

In the expression 1, the flag(Pᵢⱼ) is the value of 0 or 1 for showing the necessity of clock input for each state in each clock line (see the table in FIG. 4). In addition, prio(Sᵢ) corresponds to the state priority value 704.

A concrete example of FIG. 7 is shown by a priority value table 1510 of FIG. 15B. As mentioned earlier, FIG. 15A is a table showing the necessity of clock input for each clock line supplied to a corresponding register, for each state 1502 of the program 1100 of FIG. 11, where the necessity is specifically expressed by 0 or 1. Here 0 indicates that clock input is necessary. When it is desired to reduce the number of clock lines, the clock input table 1500 of FIG. 15B containing the priority 1513 will also be managed. Specifically, the clock input table 1510 includes values obtained by multiplying the priority 1513 by the value included in the FIG. 15A. The lowest row indicates summations respectively for clock lines. By referring to the summation values, it is possible to recognize level of power saving efficiency realized for each register due to gated clock supply. When the summation value shows a high value, the gated clock of the corresponding clock line is of a high importance, and so should be left uncombined. Considering this, two clock lines having low summation values are combined to reduce the number of clock lines by one. In the priority value table, the priority value may be set by a program designer, or may be set after simulating the circuit operation, so that the priority value may be in accordance with the number of operation in the simulation.

<Operation>

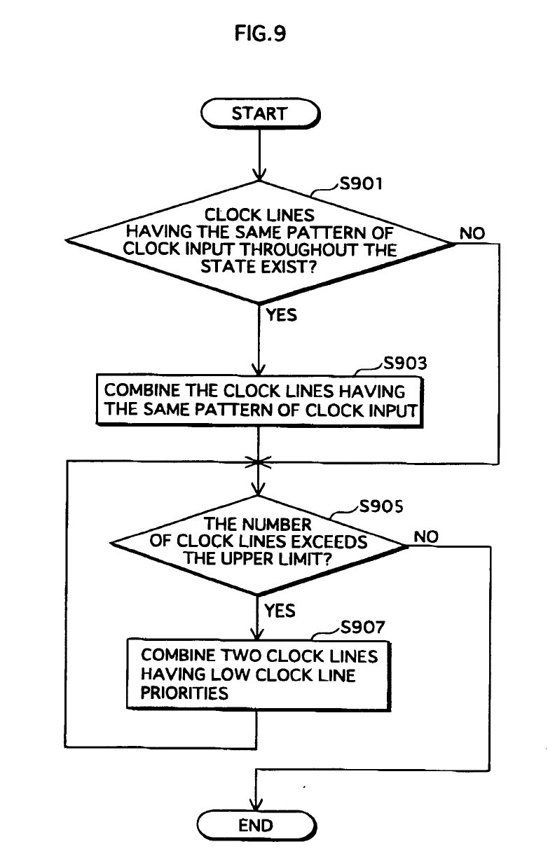

As follows, the procedure of selecting and combining the clock lines is explained with reference to the flowchart of FIG. 9. After this, concrete examples are explained with reference to the tables of FIGS. 15-19.

First, it is judged whether there are clock lines having the same gated clock throughout the states, using such a table as illustrated in FIG. 15A (Step S901). If the judgment is in the affirmative (Step S901: YES), it means that the two gated clocks are combinable without loss. Therefore the corresponding two clock lines are combined, and the table is updated (Step S903). Updating the table means to perform the logical AND between the clocks to create a new clock line. Specifically, a new clock line is created by assigning 0 to a state if any of the two clock lines indicates 0 in the state, and otherwise assigning the value obtained by adding the two values respectively for the two clock lines for the state. The priority value table is also updated, thereby proceeding to the next processing.

If the judgment of Step S901 is in the negative (Step S901: NO), nothing is performed in particular, thereby proceeding to the next processing. When the number of clock lines still exceeds the upper-limit number defined by the designer (step S905: YES), two clock lines having the lowest priority values are detected and combined, to update the table (Step S907). If there are more than three clock lines having the lowest priority value, two lines are randomly selected therefrom to be combined. This processing is repeated until the number of clock lines becomes the upper-limit number or smaller. When the number of clock lines becomes the upper-limit number of smaller, the processing is ended.

A concrete example according to the above-described procedure is described as follows. Here, suppose that the clock signal control table 1500 of FIG. 15A and the priority value table 1510 of FIG. 15B have been prepared. These tables are managed by the control signal generating unit 201 after conversion of the program 1100 of FIG. 11 into circuit design information. As indicated by the clock signal control table 1500, there are 8 clock lines for the gated clocks for supply. The following describes a process by which the 8 clock lines are reduced to 3 clock lines.

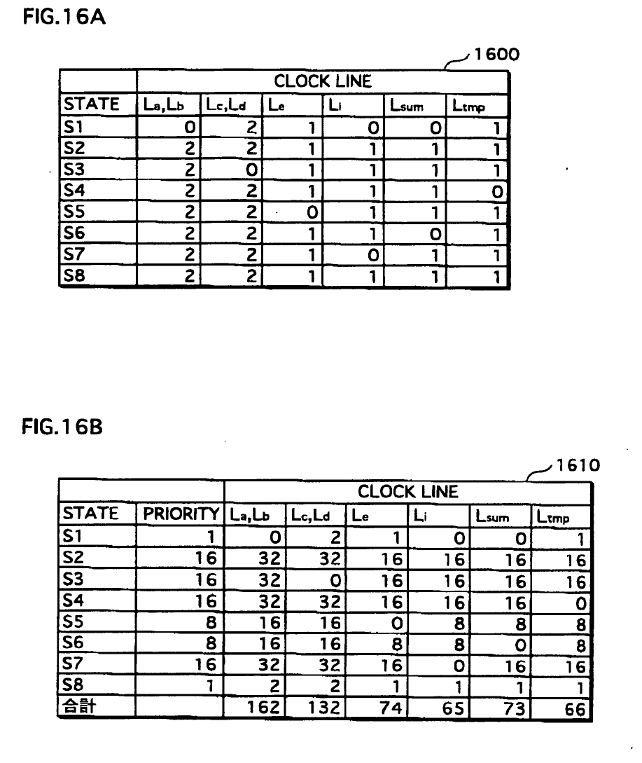

First, using the table of FIG. 15A, it is judged whether there are clock lines having the same pattern of clock input throughout the states. Here, the registers respectively corresponding to the variable a and the variable b have the same pattern of clock input throughout the states. Therefore the corresponding clock lines are combined. The same thing applies to the registers corresponding to the variable c and the variable d, and so these clock lines are also combined. As a result of the combining operations, the tables of FIGS. 15A and 15B will be updated to the tables of FIGS. 16A and 16B. This indicates that the combining operations reduced the number of clock lines to 6. In the above example, in each combining operation, two gated clocks are combined (i.e. the first operation combined two gated clocks for the registers corresponding to the variable a and the variable b; and the second operation combined two gated clocks for the registers corresponding to the variable c and the variable d). However it is possible to combine more than two gated clocks in one operation as long as they have the same pattern of clock input throughout the states. For example, suppose a case where the gated clock to be supplied to the register corresponding to the variable c indicates a pattern of “0, 1, 1, 1, 1, 1, 1, 1” (in the direction from top to bottom)in FIG. 15A. In this case, the gated clock has the same pattern as the pattern of the gated clocks respectively supplied to the registers corresponding to the variables a and the variable b. In this case, the title “Lₐ, L_{b}” in FIG. 16A will be changed to “Lₐ, L_{b}, and L_{c}”, and the values in this column will result in “0, 3, 3, 3, 3, 3, 3, 3” (in the direction from top to bottom). In addition, the title “Lₐ, L_{b}” of the priority table 1610 in FIG. 16B will also be changed to “Lₐ, L_{b}, and L_{c}”, and the values in this column will be “0, 48, 48, 48, 24, 24, 48, 3” (in the direction from top to bottom).

Next, two clock lines to be combined are selected based on the priority table 1610 of FIG. 16B. At this stage, there is no clock lines having the same pattern of clock input throughout the states. Therefore, two clock lines exhibiting low priorities are combined. Specifically, the clock lines are for the registers respectively corresponding to the variable i and the variable tmp. These clock lines are selected for combining, because of low summation values in the priority table. If a clock line exhibits a high summation value, the clock line should be left uncombined because the effect of clock gating to the clock line is high. This is why the two clock lines having low summation values are selected for combining.

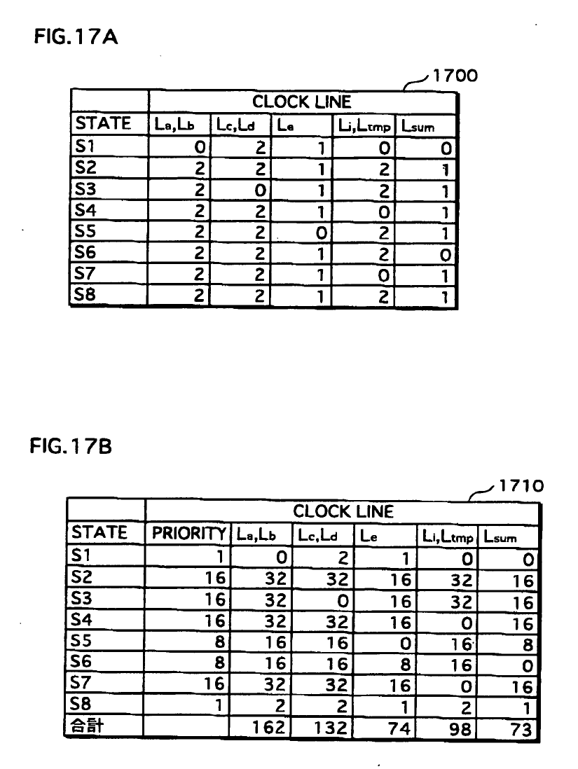

The result after combining the clock lines to be supplied to the registers corresponding to the variable i and the variable tmp is shown in the clock signal control table of FIG. 17A. As is clear from this table, the number of clock lines is reduced to 5.

As shown in FIG. 17B, the clock lines supplied to the registers corresponding to the variable e and the variable sum have low priorities, and so these clock lines are combined next.

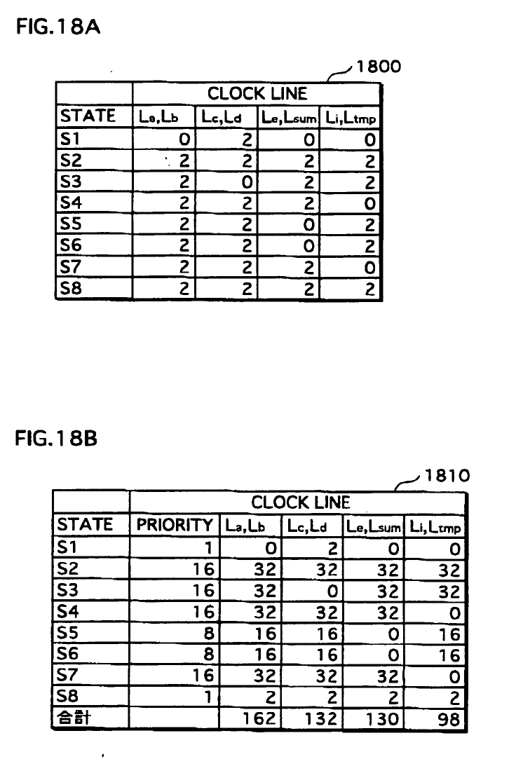

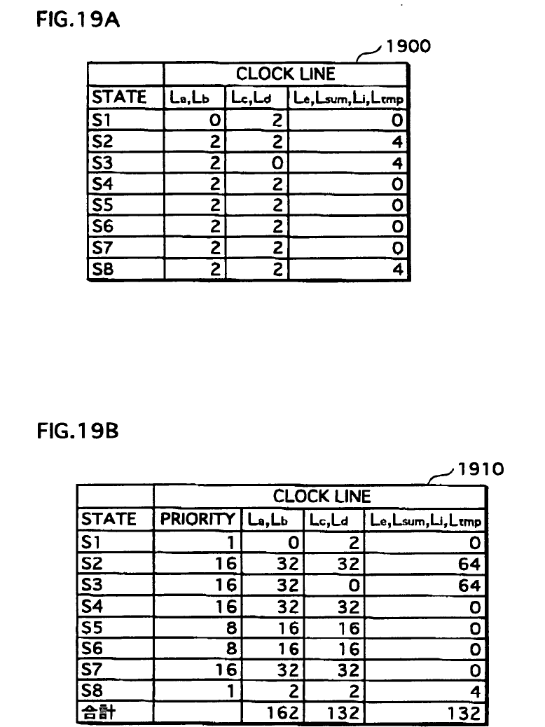

After combining the two clock lines, the number of existing clock lines is 4 as shown in FIGS. 18A and 18B. Another combining operation is performed next to generate the situation of FIGS. 19A and 19B, where the number of existing clock lines reaches 3. FIGS. 19A and 19B correspond to the final result, which indicates that a gated clock is supplied to the registers corresponding to the variables a and b, a gated clock is supplied to the registers corresponding to the variables c and d, and a gated clock is supplied to the registers corresponding to the variables e, sum, i, and tmp.

(Complementary Notes)

So far, the circuit information generating apparatus 100 relating to the present invention has been described by way of the embodiments. However, the present invention should not be limited to the described embodiments, and various modifications are possible. The following describes some of such modification examples.

In the above-described embodiments, a C language program is used as an input. However, the input is not limited a C language program, as long as it is a circuit operation description that is sufficient for structuring the state machine and the operation processing unit 204. For example, a program described in HDL (hardware description language), and circuit design information described in RTL to which clock gating is not performed may also be used as the input.

In addition, the above described embodiments output circuit design information described in RTL. However, the output is not limited to information described in RTL, as long as it is information indicating a circuit structure sufficient for actually producing the circuits. For example, a C language program in which description of clocks is permitted may also be used as the output.

In addition, each functional unit that generates information in the circuit information generating apparatus is not limited to a circuit only composed of hardware. Each functional unit may include software and perform its function by execution of the software. In this case, each functional unit may be provided with a processor executing the software. Alternatively, one processor may be provided for a plurality of functional units. In addition, the circuit information generating apparatus 100 may be realized by a part or all of an LSI, a VLSI (very large scale integration), and the like. Furthermore, the circuit information generating apparatus 100 may be realized by a plurality of LSI, and the like. Still further, the circuit information generating apparatus 100 may be realized by a combination of at least one LSI, at least a different circuit, and the like.

In the first embodiment, information including the control signal adjusting unit 205 is generated. However if delay will not occur, generating of such information becomes unnecessary.

Furthermore in the first embodiment, the control signal generating unit 201 manages the clock signal control table 400 so as to output a clock control signal 211. However another structure is also possible that the control signal generating unit 201 analyzes the contents of a current state each time a sate signal 214 is received, without retaining the clock signal control table 400. However this case assumes non-occurrence of delay.

In the second embodiment, the circuit information generating apparatus 100 is employed to reduce the number of gated clocks. However, it is alternatively possible to adopt software or hardware exclusively performing reduction of the number of gated clocks with use of the method described in the second embodiment.

Furthermore in the second embodiment, a clock line priority value for a state is obtained by multiplying a value indicating whether to supply a clock in the state, by the state's priority value. However, it is possible to multiply thus obtained value by the power consumed in a corresponding clock line if clock input is performed in the state. By doing so, a more accurate priority value for the clock line is determined.

Although the present invention has been fully described byway of examples with references to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A circuit information generating apparatus comprising:
an obtaining unit operable to obtain functional structure information and execution sequence information from outside, the functional structure information defining a structure of a function and the execution sequence information defining an execution sequence of the function;
a structure information generating unit operable to generate, according to the execution sequence information and the functional structure information, circuit structure information in register transfer level which defines a plurality of circuits that execute the function according to the execution sequence;
a gated clock information generating unit operable to generate, according to the execution sequence information and the functional structure information, gated clock information in register transfer level which defines a clock control circuit that supplies, to each of at least one of the circuits, a gated clock that is set to halt clock input when the clock input is unnecessary; and
an outputting unit operable to output the gated clock information together with the circuit structure information.

2. The circuit information generating apparatus of claim 1, wherein
the execution sequence is composed of a plurality of states, each state being assigned a corresponding position in the execution sequence and including at least one instruction,
the structure information generating unit includes:
a first information generating subunit operable to generate first information defining a state machine that manages the states and outputs a state signal, the state signal indicating which order of the execution sequence a particular state corresponds to; and
a second information generating subunit operable to generate second information defining an operation processing circuit that executes contents of the state according to the state signal,
the gated clock information generating unit includes:
a third information generating subunit operable to generate third information defining a control signal generating circuit, the control signal generating circuit retaining a clock signal control table indicating, for each of the circuits and according to each of the states, whether clock input to the circuit is necessary, and generating a clock control signal conforming to the state signal after reception of the state signal; and
a fourth information generating subunit operable to generate fourth information defining a clock gating circuit that, according to the clock control signal, generates a gated clock that is set to halt clock input while a corresponding circuit is not functioning and supplies the gated clock to the operation processing circuit,
the circuit structure information is generated to include the first information and the second information, and
the gated clock information is generated to include the third information and the fourth information.

3. The circuit information generating apparatus of claim 2, wherein
the gated clock information generating unit further includes:
a fifth information generating subunit operable to generate fifth information defining a control signal adjusting circuit that generates an adjusted clock control signal by correcting delay of the clock control signal after receiving the clock control signal, and
generates the gated clock information to include therein the fifth information.

4. The circuit information generating apparatus of claim 2, wherein
the control signal generating circuit:
retains a priority value table that indicates, for each of circuits included in the operation processing circuit, a power reducing effect expected of gated clock supply to the circuit included in the operation processing circuit; and
detects, using the priority value table, two gated clocks respectively to be supplied to two circuits exhibiting lowest power reducing effects of the circuits included in the operation processing circuit, and
the clock control circuit combines the detected two gated clocks to generate a combined gated clock, and supplies the combined gated clock to the two circuits.

5. The circuit information generating apparatus of claim 1, wherein
the obtaining unit obtains a program in C language which includes the functional structure information and the execution sequence information.

6. A circuit information generating method for generating circuit information incorporating therein a clock gating circuit, the method comprising:
an obtaining step of obtaining functional structure information and execution sequence information from outside, the functional structure information defining a structure of a function and the execution sequence information defining an execution sequence of the function;
a structure information generating step of generating, according to the execution sequence information and the functional structure information, circuit structure information in register transfer level which defines a plurality of circuits that execute the function according to the execution sequence;
a gated clock information generating step of generating, according to the execution sequence information and the functional structure information, gated clock information in register transfer level which defines a clock control circuit that supplies, to each of at least one of the circuits, a gated clock that is set to halt clock input when the clock input is unnecessary; and
an outputting step of outputting the gated clock information together with the circuit structure information.

7. The circuit information generating method of claim 6, wherein
the execution sequence is composed of a plurality of states, each state being assigned a corresponding position in the execution sequence and including at least one instruction,
the structure information generating step includes:
a first information generating substep of generating first information defining a state machine that manages the states and outputs a state signal, the state signal indicating which order of the execution sequence a particular state corresponds to; and
a second information generating substep of generating second information defining an operation processing circuit that executes contents of the state according to the state signal,
the gated clock information generating step includes:
a third information generating substep of generating third information defining a control signal generating circuit, the control signal generating circuit retaining a clock signal control table indicating, for each of the circuits and according to each of the states, whether clock input to the circuit is necessary, and generating a clock control signal conforming to the state signal after reception of the state signal; and
a fourth information generating substep of generating fourth information defining a clock gating circuit that, according to the clock control signal, generates a gated clock that is set to halt clock input while a corresponding circuit is not functioning and supplies the gated clock to the operation processing circuit,
the circuit structure information is generated to include the first information and the second information, and
the gated clock information is generated to include the third information and the fourth information.

8. The circuit information generating method of claim 7, wherein
the gated clock information generating step further includes:
a fifth information generating substep of generating fifth information defining a control signal adjusting circuit that generates an adjusted clock control signal by correcting delay of the clock control signal after receiving the clock control signal, and
generates the gated clock information to include therein the fifth information.

9. A gated-clock combining method of combining gated clocks supplied to a plurality of circuits respectively, the method comprising:
a retaining step of retaining a priority value table that indicates, for each of a plurality of circuits included in an operation processing circuit, a power reducing effect expected of gated clock supply to the circuit included in the operation processing circuit;
a detecting step of, using the priority value table, detecting two gated clocks respectively to be supplied to two circuits exhibiting lowest power reducing effects of the circuits included in the operation processing circuit;
a combining step of combining the detected two gated locks to generate a combined gated clock; and
a supplying step of supplying the combined gated clock to the two circuits.

10. A circuit information generating program for generating circuit information incorporating therein a clock gating circuit, the program being fur executing:
an obtaining step of obtaining functional structure information and execution sequence information from outside, the functional structure information
defining a structure of a function and the execution sequence information defining an execution sequence of the function;
a structure information generating step of generating, according to the execution sequence information and the functional structure information, circuit structure information in register transfer level which defines a plurality of circuits that execute the function according to the execution sequence;
a gated clock information generating step of generating, according to the execution sequence information and the functional structure information, gated clock information in register transfer level which defines a clock control circuit that supplies, to each of at least one of the circuits, a gated clock that is set to halt clock input when the clock input is unnecessary; and
an outputting step of outputting the gated clock information together with the circuit structure information.

11. The circuit information generating program of claim 10, wherein
the execution sequence is composed of a plurality of states, each state being assigned a corresponding position in the execution sequence and including at least one instruction,
the structure information generating step includes:
a first information generating substep of generating first information defining a state machine that manages the states and outputs a state signal, the state signal indicating which order of the execution sequence a particular state corresponds to; and
a second information generating substep of generating second information defining an operation processing circuit that executes contents of the state according to the state signal,
the gated clock information generating step includes:
a third information generating substep of generating third information defining a control signal generating circuit, the control signal generating circuit retaining a clock signal control table indicating, for each of the circuits and according to each of the states, whether clock input to the circuit is necessary, and generating a clock control signal conforming to the state signal after reception of the state signal; and
a fourth information generating substep of generating fourth information defining a clock gating circuit that, according to the clock control signal, generates a gated clock that is set to halt clock input while a corresponding circuit is not functioning and supplies the gated clock to the operation processing circuit,
the circuit structure information is generated to include the first information and the second information, and
the gated clock information is generated to include the third information and the fourth information.

12. The circuit information generating program of claim 11, wherein
the gated clock information generating step further includes:
a fifth information generating substep of generating fifth information defining a control signal adjusting circuit that generates an adjusted clock control signal by correcting delay of the clock control signal after receiving the clock control signal, and
generates the gated clock information to include therein the fifth information.

13. A gated-clock combining program for combining gated clocks supplied to a plurality of circuit respectively, the program being for executing:
a retaining step of retaining a priority value table that indicates, for each of a plurality of circuits included in an operation processing circuit, a power reducing effect expected of gated clock supply to the circuit included in the operation processing circuit;
a detecting step of, using the priority value table, detecting two gated clocks respectively to be supplied to two circuits exhibiting lowest power reducing effects of the circuits included in the operation processing circuit;
a combining step of combining the detected two gated clocks to generate a combined gated clock; and
a supplying step of supplying the combined gated clock to the two circuits.
